(19) United States
(12) Patent Application Publication
(10) Pub. No.: US 2007/0198251 A1
(43) Pub. Date: Aug. 23, 2007

(54) VOICE ACTIVITY DETECTION METHOD AND APPARATUS FOR VOICED/UNVOICED DECISION AND PITCH ESTIMATION IN A NOISY SPEECH FEATURE EXTRACTION

(75) Inventor: Marwan Jaber, Montreal, QC (CA)

Correspondence Address: VOLPE AND KOENIG, P.C., UNITED PLAZA, SUITE 1600, 30 SOUTH 17TH STREET, PHILADELPHIA, PA, 19103, US

(73) Assignee: JABER ASSOCIATES, L.L.C., Wilmington, DE (US)

(21) Appl. No.: 11/672,106

(22) Filed: Feb. 7, 2007

Related U.S. Application Data
(60) Provisional application No. 60/771,167, filed on Feb. 7, 2006.

(51) Int. Cl. G10L 21/00

(52) U.S. Cl. 704/213

(57) ABSTRACT

The present invention is related to a method and apparatus for voice activity detection (VAD) in which a set of measurements are made over the interval of a processed frame, and which are used to determine if segments of the frame contain voiced or unvoiced signals. The proposed measurements include the mean of the log energy of noise over the time, the zero crossing count, and the autocorrelation coefficient. The present invention may be used in speech enhancement or signal de-noising applications.

### CROSS REFERENCE TO RELATED APPLICATION

This application claims the benefit of U.S. Provisional Application No. 60/771,167, filed Feb. 7, 2006 which is incorporated by reference as if fully set forth.

### FIELD OF INVENTION

The present invention is related to a method and apparatus for voiced/unvoiced decision and pitch estimation.

### BACKGROUND

Speech detection is a crucial issue in adaptive speech enhancement algorithms. The need for deciding whether a given segment of a voiced noisy signal should be classified as voiced or unvoiced arises in many speech enhancement or signal de-noising applications. A variety of approaches have been described in the prior art for making this decision. The success of a hypothesis testing depends, to a considerable extent, upon the measurements or features which are used in the decision criterion. The basic problem addressed by the present invention is of selecting features or measurements which are simple to derive from speech and yet are highly effective in differentiating between voiced and unvoiced segments.

### SUMMARY

The present invention is related to a method and apparatus for detecting voice activity in a voiced noisy signal, which may be applied in speech enhancement or signal de-noising applications. The present invention can use any of the following speech measurements in deciding if a segment of a signal is voiced or unvoiced: the mean of the log energy of noise over the time, the zero crossing count, and the autocorrelation coefficient.

### BRIEF DESCRIPTION OF THE DRAWINGS

FIG. 1 is an example of a voice activity detector (VAD) module in accordance with the present invention.

FIG. 2 illustrates preferred embodiments of the measurement computation module and the speech detection decision module in accordance with the present invention.

FIG. 3 is a block circuit diagram of a measurement module in accordance with the present invention.

FIG. 4 is a block circuit diagram mean of a zero crossing count module in a noise segment in accordance with the present invention.

FIG. 5 is a block circuit diagram of a threshold computation module in accordance with the present invention.

FIG. 6 is a block circuit diagram of a log energy computation module in accordance with the present invention.

FIG. 7 is a block circuit diagram of an autocorrelation function computation module in accordance with the present invention.

FIG. 8 is a block circuit diagram of an energy computation module in accordance with the present invention.

FIG. 9 is a block circuit diagram of a first decision rule module in accordance with the present invention.

FIG. 10 is a block circuit diagram of a second decision rule module in accordance with the present invention.

FIG. 11 is a block circuit diagram of a third decision rule module in accordance with the present invention.

FIG. 12 is a block circuit diagram of a fourth decision rule module in accordance with the present invention.

FIG. 13 is a block circuit diagram of a fifth decision rule module in accordance with the present invention.

FIG. 14 is a block circuit diagram of a sixth decision rule module in accordance with the present invention.

FIG. 15 illustrates simulation result in which the first plot is a plot of a noisy signal, the second plot is the plot of the output of the proposed voice activity detection (VAD) algorithm of the present invention and the third plot is the simulation result.

FIG. 16 is a flowchart of the software implementation of a voice activity detector (VAD) module in accordance with the present invention.

### DETAILED DESCRIPTION OF THE PREFERRED EMBODIMENTS

The present invention provides a method and apparatus for deciding whether a given segment of a voiced noisy signal should be classified as voiced or unvoiced, as used in speech enhancement or signal de-noising applications. The present invention proposes to use the following speech measurements for the voiced/unvoiced decision:
the mean of the log energy over the time,
zero crossing count, and/or
the autocorrelation coefficient R[1].

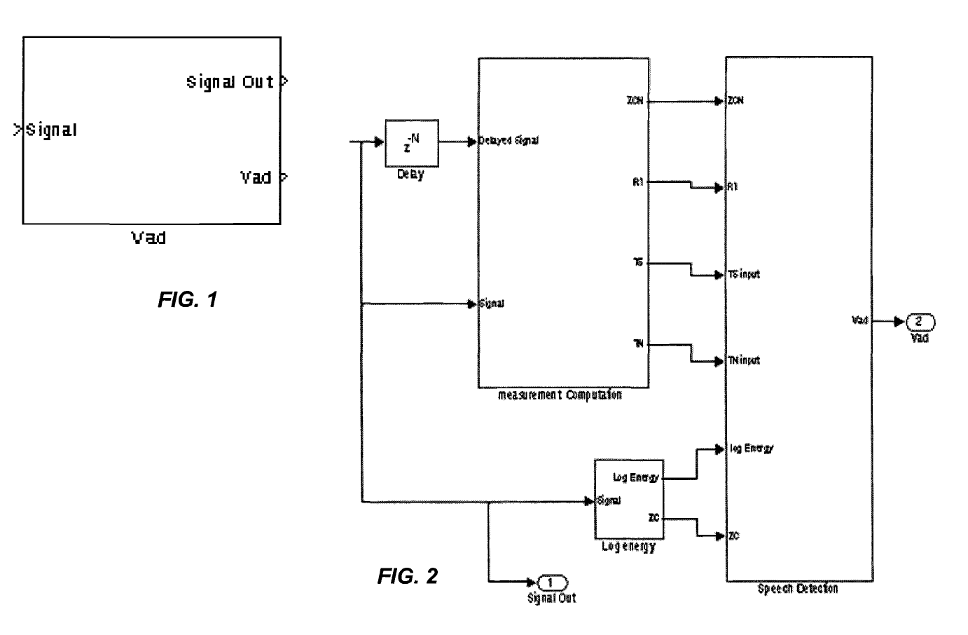

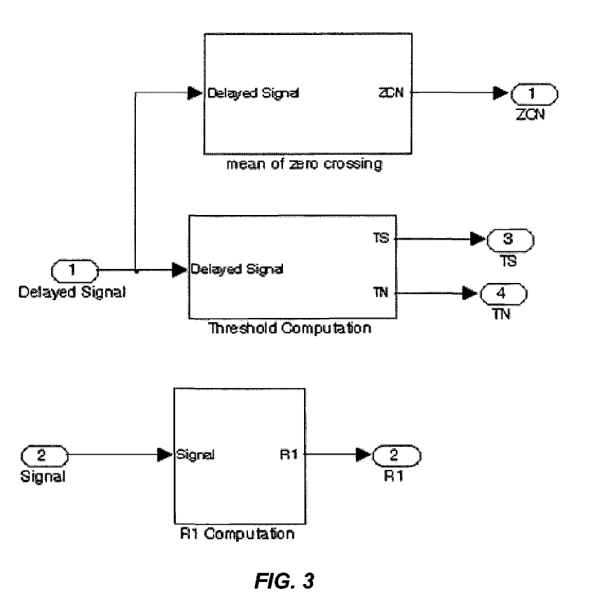

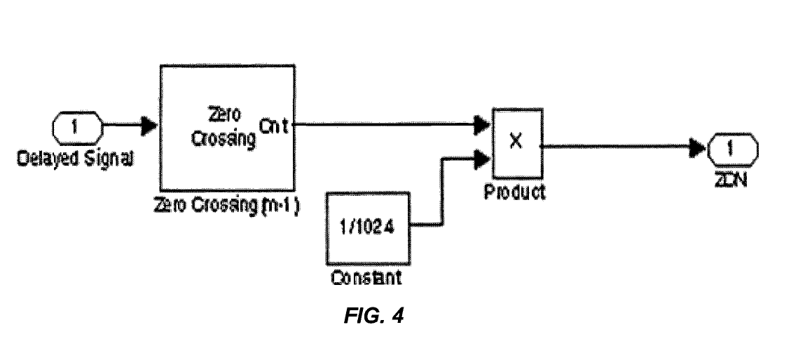

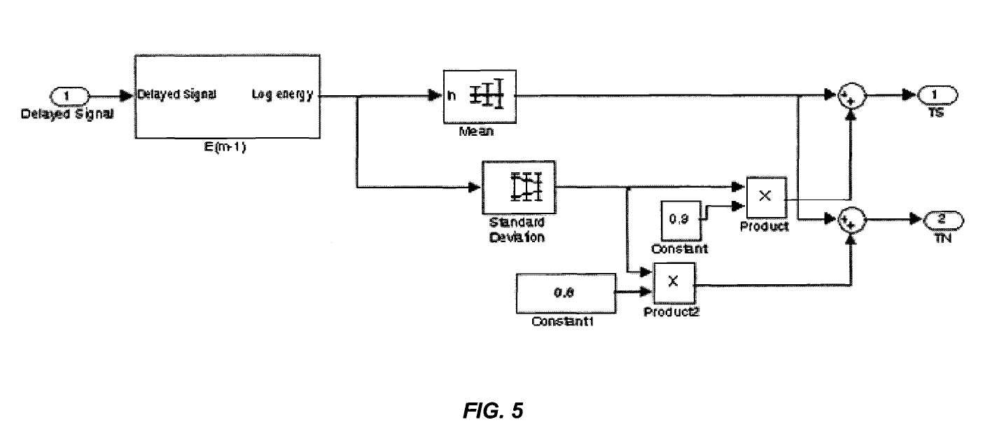

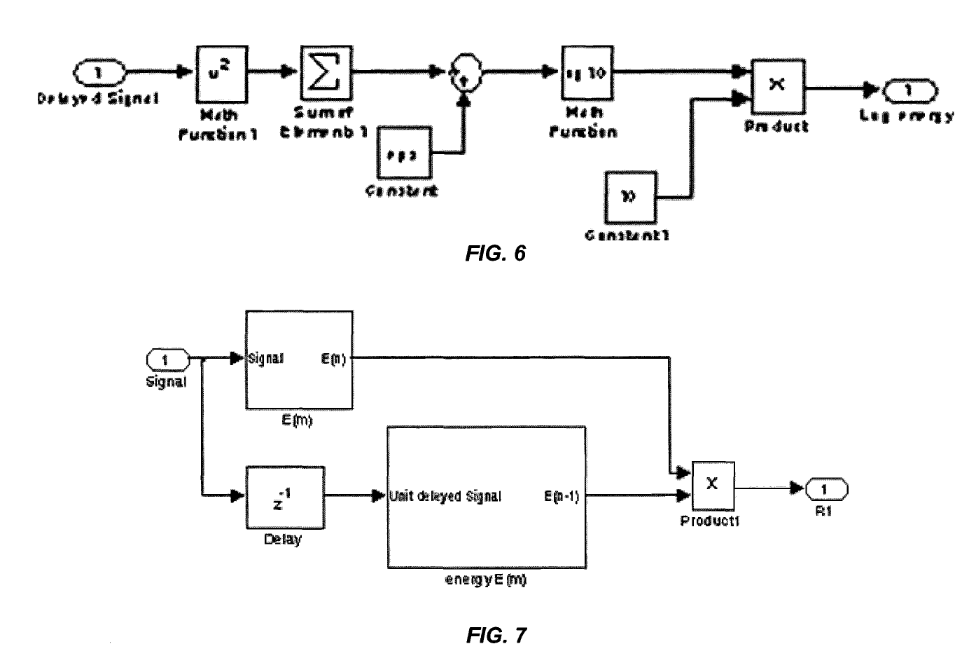

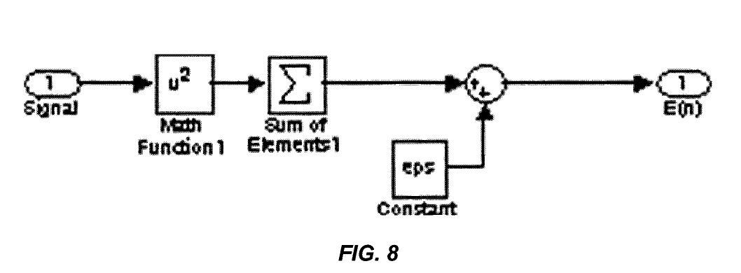

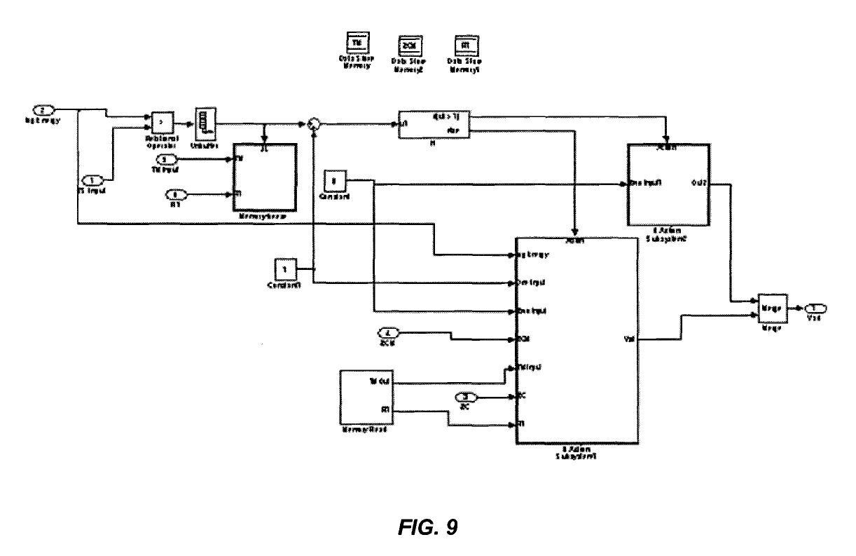

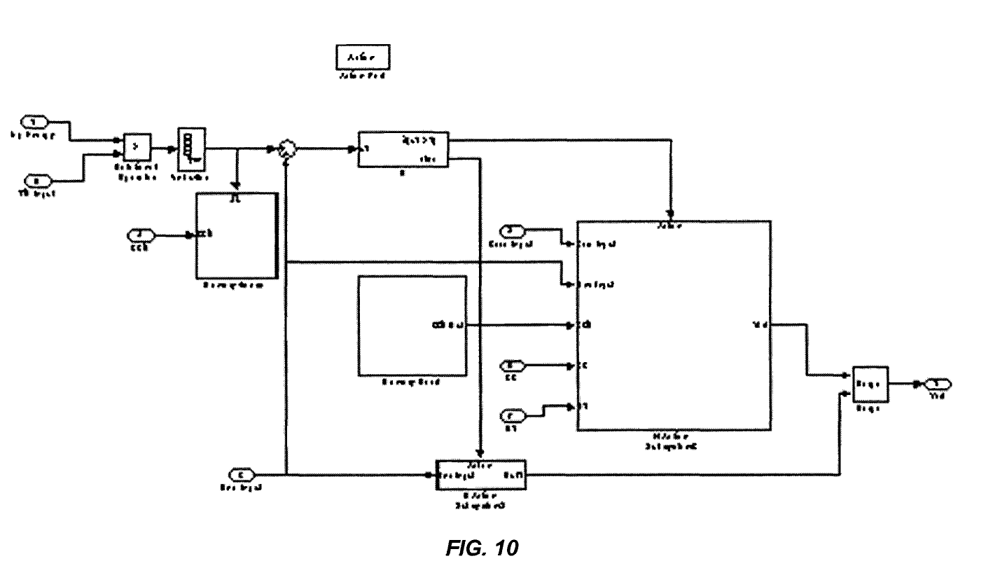

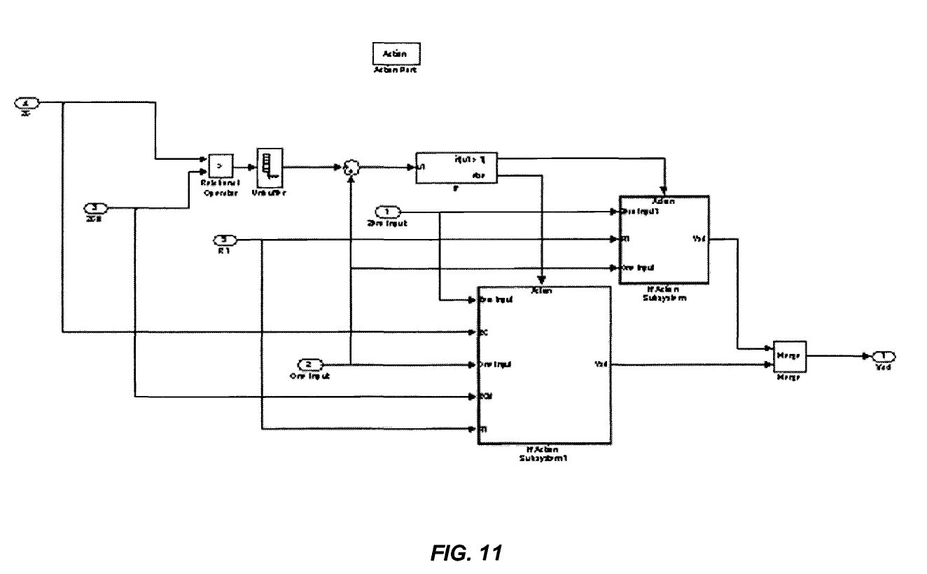

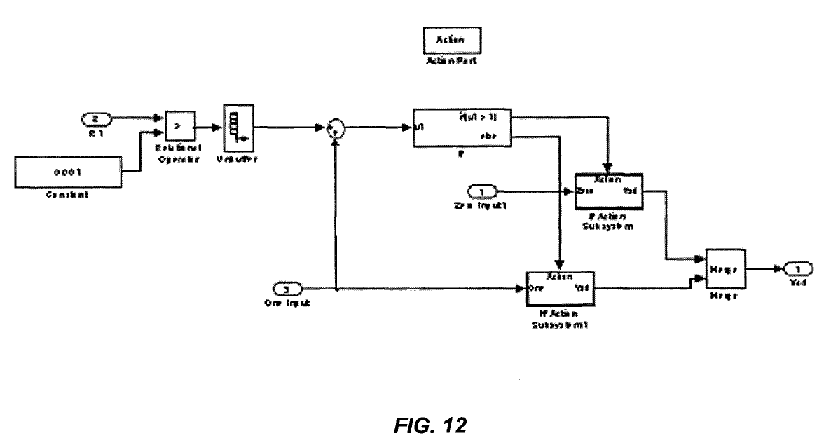

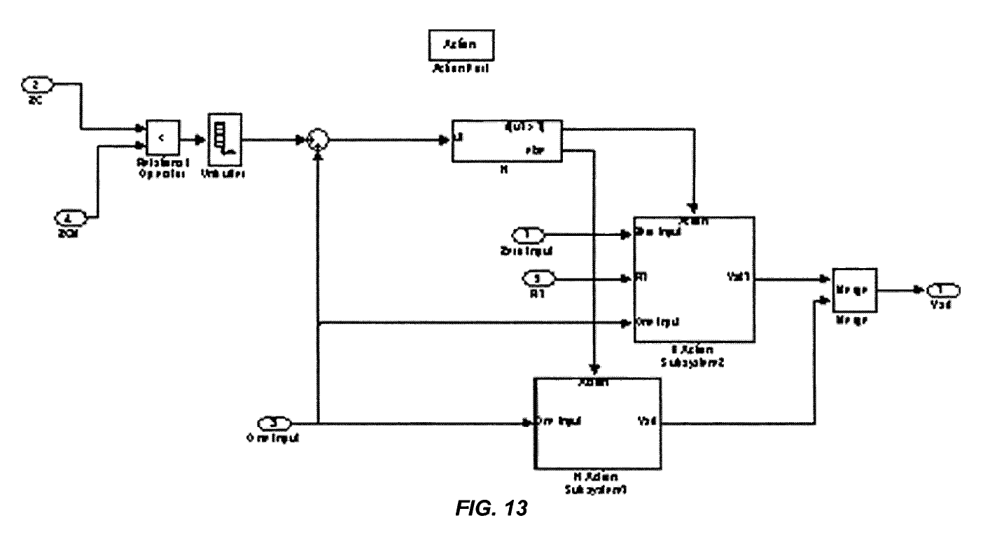

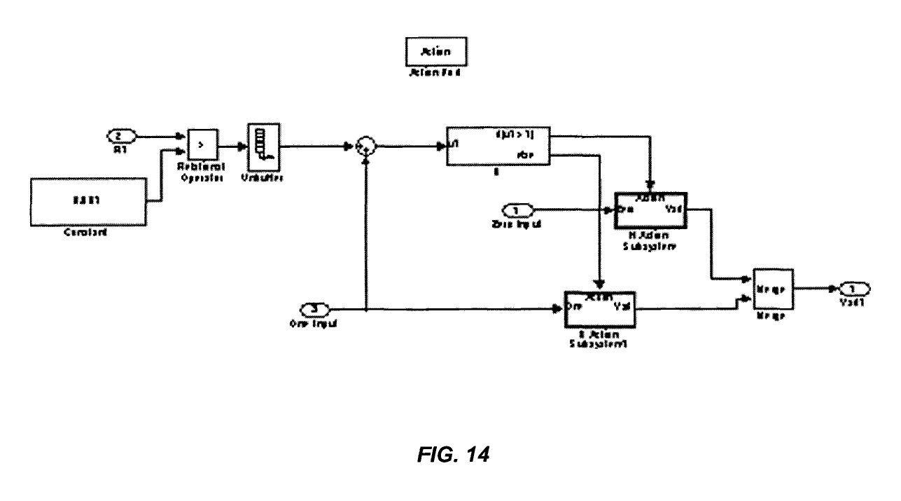

The various components associated with different embodiments of the present invention are illustrated in FIGS. 1 through 14. The proposed speech measurement techniques are discussed below.

Log Energy Speech Measurement

According to the present invention, a novel strategy is developed in which the noise characteristics are tracked more reliably and used to set a speech threshold adaptively. The method is called dynamic detection. Dynamic detection can work in real time and with minimal processing delay. It computes the speech threshold Tₛ from the estimated mean and variance of the log-energy of the noise, according to Equation 1.
Tₛ=μₙ+ασₙ Equation 1

A noise threshold Tₙ is calculated where the log energy E is defined as:

$$E = 10 {log}_{10} ( ɛ + {\sum }_{n = 1}^{N} {S}^{2} ) \qquad Equation 2$$

Zero Crossing Count Speech Measurement

The zero crossing count is an indicator of the frequency at which the energy is concentrated in the signal spectrum. Voiced speech is produced as a result of excitation of the vocal tract by the periodic flow of air at the glottis and usually shows a low zero crossing count. The front point speech is produced due to excitation of the vocal tract by the noise-like source at a point of constriction in the interior of the vocal tract and shows a high zero crossing count. The zero crossing of the end point speech shows is expected to be lower than the front-point speech, but quite comparable to that for voiced speech.

The Autocorrelation Coefficient R[1] Speech Measurement

This measurement is a useful tool to distinguish between sonorant and fricative segment of speech at beginning or end of utterances. Sonorant speech usually shows a big value of R.

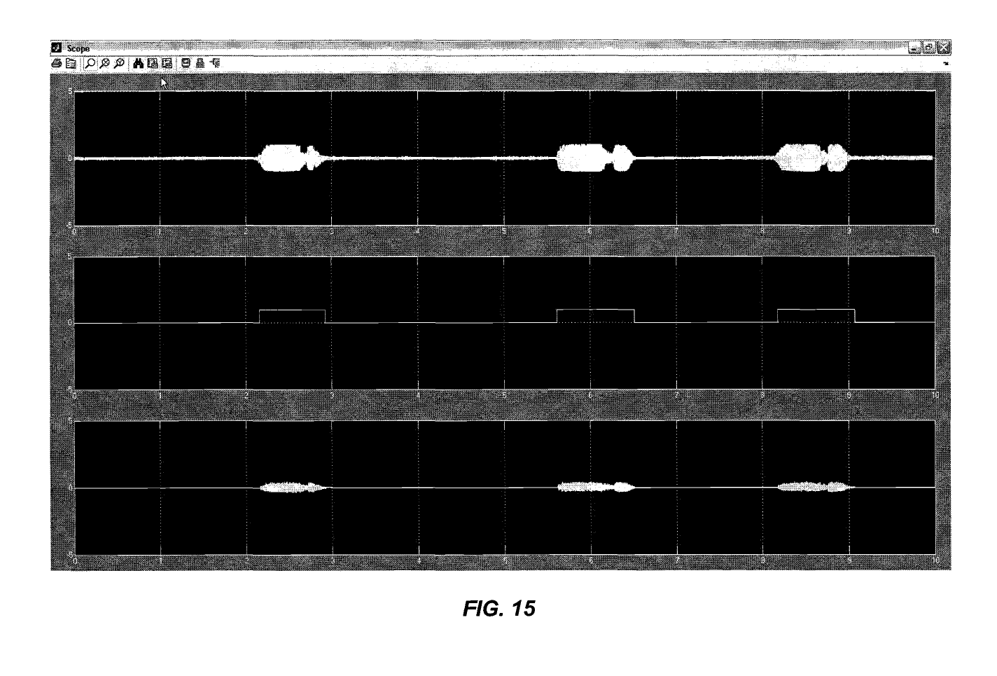

The present invention includes a fairly general framework based on voice activity detection (VAD) in which a set of measurements are made on the interval of the processed frame, such as the types of measurements discussed above. Simulation results presented in FIG. 15 show the accuracy of our VAD in detecting the speech segment from the front point to the end point.

Software Implementation

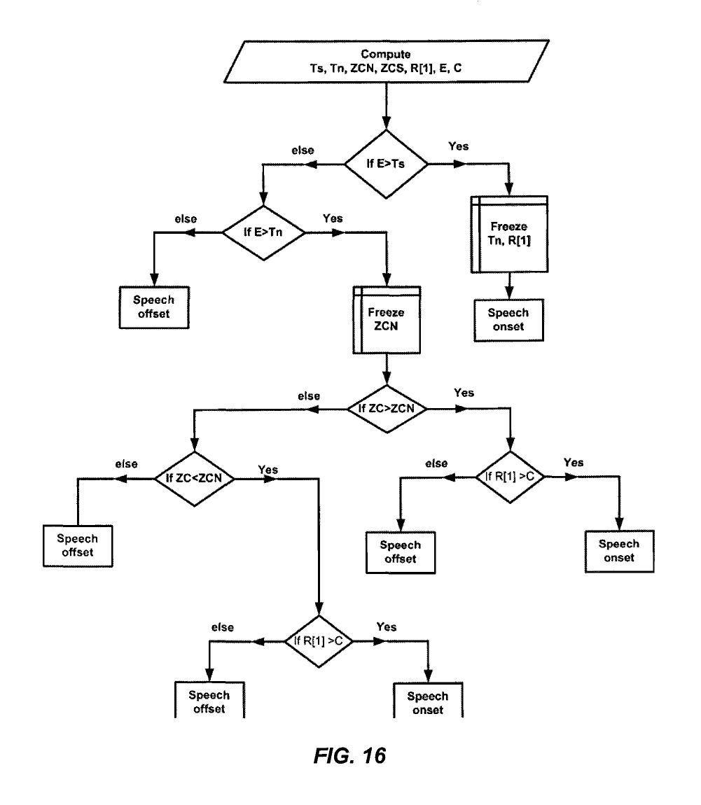

The proposed voice activity detection (VAD) algorithm may be implemented in software as shown in the flow chart of FIG. 16 in which
Tₛ is the threshold in the speech segment,
Tₙ is the threshold in the noise segment,
E is the mean of the log energy of the current processed frame,
ZC is the mean of the zero crossing count of the current processed frame,
ZCS is the mean of the zero crossing count of the speech segment,
ZCN is the mean of the zero crossing count of the noise segment,
R[1] is the autocorrelation in the noise segment, and
C is a comparative constant.

Although the features and elements of the present invention are described in the preferred embodiments in particular combinations, each feature or element can be used alone without the other features and elements of the preferred embodiments or in various combinations with or without other features and elements of the present invention.

What is claimed is:

1. A method for voice activity detection (VAD) comprising:
taking a set of measurements over an interval of a processed frame; and
differentiating between voiced and unvoiced segments of the processed frame based on said measurements.

2. The method of claim 1 wherein the measurements are based on a mean of log energy of noise over the time.

3. (canceled)

4. (canceled)
